(19) United States
(12) Patent Application Publication
(10) Pub. No.: US 2010/0074381 A1
(43) Pub. Date: Mar. 25, 2010

(54) METHODS AND SYSTEMS FOR IMPROVING ITERATIVE SIGNAL PROCESSING

(75) Inventors: Warren GROSS, Montreal (CA); Shie MANNOR, Montreal (CA); Saeed SHARIFI TEHRANI, Montreal (CA)

Correspondence Address: FREEDMAN & ASSOCIATES, 117 CENTREPOINTE DRIVE, SUITE 350, NEPEAN, ONTARIO, K2G 5X3, CA

(73) Assignee: The Royal Institution for the Advancement of Learning/ McGill University, Montreal (CA)

(21) Appl. No.: 12/566,829

(22) Filed: Sep. 25, 2009

Related U.S. Application Data
(60) Provisional application No. 61/099,923, filed on Sep. 25, 2008.

(51) Int. Cl. H04B 1/10; H04L 27/00

(52) U.S. Cl. 375/346; 375/316

(57) ABSTRACT

A method for iteratively decoding a set of encoded samples received from a transmission channel is provided. A data signal indicative of a noise level of the transmission channel is received. A scaling factor is then determined in dependence upon the data signal and the encoded samples are scaled using the scaling factor. The scaled encoded samples are then iteratively decoded. Furthermore, a method for initializing edge memories is provided. During an initialization phase initialization symbols are received from a node of a logic circuitry and stored in a respective edge memory. The initialization phase is terminated when the received symbols occupy a predetermined portion of the edge memory. An iterative process is executed using the logic circuitry storing output symbols received from the node in the edge memory and a symbol is retrieved from the edge memory and provided as output symbol of the node. Yet further an architecture for a high degree variable node is provided. A plurality of sub nodes forms a variable node for performing an equality function in an iterative decoding process. Internal memory is interposed between the sub nodes such that the internal memory is connected to an output port of a respective sub node and to an input port of a following sub node, the internal memory for providing a chosen symbol if a respective sub node is in a hold state, and wherein at least two sub nodes share a same internal memory.

### FIELD OF THE INVENTION

The instant invention relates to the field of iterative signal processing and in particular to methods and systems for improving performance of iterative signal processing.

### BACKGROUND

Data communication systems comprise three components: a transmitter; a transmission channel; and a receiver. Transmitted data become altered due to noise corruption and channel distortion. To reduce the presence of errors caused by noise corruption and channel distortion, redundancy is intentionally introduced, and the receiver uses a decoder to make corrections. In modern data communication systems, the use of error correction codes plays a fundamental role in achieving transmission accuracy, as well as in increasing spectrum efficiency. Using error correction codes, the transmitter encodes the data by adding parity check information and sends the encoded data through the transmission channel to the receiver. The receiver uses the decoder to decode the received data and to make corrections using the added parity check information.

Stochastic computation was introduced in the 1960's as a method to design low precision digital circuits. Stochastic computation has been used, for example, in neural networks. The main feature of stochastic computation is that probabilities are represented as streams of digital bits which are manipulated using simple circuitry. Its simplicity has made it attractive for the implementation of error correcting decoders in which complexity and routing congestion are major problems, as disclosed, for example, in W. Gross, V. Gaudet, and A. Milner: “Stochastic implementation of LDPC decoders”, in the 39^{th} Asilomar Conf. on Signals, Systems, and Computers, Pacific Grove, Calif., November 2005.

A major difficulty observed in stochastic decoding is the sensitivity to the level of switching activity—bit transition—for proper decoding operation, i.e. switching events become too rare and a group of nodes become locked into one state. To overcome this “latching” problem, Noise Dependent Scaling (NDS), Edge Memories (EMs), and Internal Memories (IMs) have been implemented to re-randomize and/or de-correlate the stochastic signal data streams as disclosed, for example, in US Patent Application 20080077839 and U.S. patent application Ser. No. 12/153,749 (not yet published).

It would be desirable to provide methods and systems for improving performance of iterative signal processing such as, for example, stochastic decoding.

### SUMMARY OF EMBODIMENTS OF THE INVENTION

In accordance with an aspect of the present invention there is provided a method for iteratively decoding a set of encoded samples comprising: receiving from a transmission channel the set of encoded samples; receiving a data signal indicative of a noise level of the transmission channel; determining a scaling factor in dependence upon the data signal; determining scaled encoded samples by scaling the encoded samples using the scaling factor; iteratively decoding the scaled encoded samples.

In accordance with an aspect of the present invention there is provided a method for iteratively decoding a set of encoded samples comprising: receiving the set of encoded samples; decoding the encoded samples using an iterative decoding process comprising: monitoring a level of a characteristic related to the iterative decoding process and providing a data signal in dependence thereupon; determining a scaling factor in dependence upon the data signal; and, scaling the encoded samples using the scaling factor.

In accordance with an aspect of the present invention there is provided a scaling system comprising: an input port for receiving a set of encoded samples, the set of encoded samples for being decoded using an iterative decoding process; a monitor for monitoring one of a noise level of a transmission channel used for transmitting the encoded samples and a level of a characteristic related to the iterative decoding process and providing a data signal in dependence thereupon; scaling circuitry connected to the input port and the monitor, the scaling circuitry for determining a scaling factor in dependence upon the data signal and for determining scaled encoded samples by scaling the encoded samples using the scaling factor; and, an output port connected to the scaling circuitry for providing the scaled encoded samples.

In accordance with an aspect of the present invention there is provided a method comprising: during an initialization phase receiving initialization symbols from a node of a logic circuitry; storing the initialization symbols in a respective edge memory; terminating the initialization phase when the received symbols occupy a predetermined portion of the edge memory; executing an iterative process using the logic circuitry storing output symbols received from the node in the edge memory; and, retrieving a symbol from the edge memory and providing the same as output symbol of the node.

In accordance with an aspect of the present invention there is provided a logic circuitry comprising: a plurality of sub nodes forming a variable node for performing an equality function in an iterative decoding process; internal memory interposed between the sub nodes such that the internal memory is connected to an output port of a respective sub node and to an input port of a following sub node, the internal memory for providing a chosen symbol if a respective sub node is in a hold state, and wherein at least two sub nodes share a same internal memory.

### BRIEF DESCRIPTION OF THE FIGURES

Exemplary embodiments of the invention will now be described in conjunction with the following drawings, in which:

FIGS. 1 and 2 are simplified flow diagrams of a method for iteratively decoding a set of encoded samples according to embodiments of the invention;

FIG. 3 is a simplified block diagram illustrating a scaling system according to an embodiment of the invention;

FIG. 4 is a simplified block diagram of a VN with an EM;

FIG. 5 is a simplified flow diagram of a method for initializing edge memory according to an embodiment of the invention;

FIGS. 6a and 6b are simplified block diagrams of a 7-degree VN;

FIG. 7 is a simplified block diagram of a high degree VN according to an embodiment of the invention; and

FIG. 8 is a simplified block diagram for a very high degree VN according to an embodiment of the invention.

### DETAILED DESCRIPTION OF EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

While embodiments of the invention will be described for stochastic decoding for the sake of simplicity, it will become evident to those skilled in the art that the embodiments of the invention are not limited thereto, but are also applicable for other types of decoding such as, for example, bit-serial and bit flipping decoding, as well as for other types of stochastic processing.

In the description hereinbelow mathematical terms such as, for example, optimization are used for clarity, but as is evident to one skilled in the art these terms are not to be considered as being strictly absolute, but to also include degrees of approximation depending, for example, on the application or technology.

For simplicity, the various embodiments of the invention are described hereinbelow using a bitwise representation, but it will be apparent to those skilled in the art that they are also implementable using a symbol-wise representation, for example, symbols comprising a plurality of bits or non-binary symbols.

In Noise Dependent Scaling (NDS) channel reliabilities are scaled as follows:

L′=(αN₀/Y)L, (1)

where L is the channel Log-Likelihood Ratio (LLR), N₀ is the power-spectral density of Additive White Gaussian Noise (AWGN) that exists in the channel and Y is a maximum limit of symbols, which is varying for different modulations, and α is a scaling factor—or NDS parameter which is, for example, determined such that: a Bit-Error-Rate (BER) performance of the decoder; a convergence behavior of the decoder; or a switching activity behavior of the decoder is optimized. The value of the scaling factor α for achieving substantially optimum performance depends on the type of code used.

Furthermore, the value of the scaling factor α for achieving substantially optimum performance also depends on the Signal-to-Noise-Ratio (SNR)—i.e. the noise level—of the transmission channel for a same type of code. This implies that, for example, at SNR₁ the decoder achieves optimum performance with α₁, and at SNR₂ the decoder achieves optimum performance with α₂.

Therefore, in the scaling method according to embodiments of the invention described herein below, the scaling factor α is not a fixed value but is varied in dependence upon the values of the SNR. In an embodiment according to the invention, a plurality of scaling factors corresponding to respective SNRs—SNR points or SNR ranges—are determined such that a predetermined performance—BER; convergence; switching activity—of the decoder is optimized. The determined scaling factors and the corresponding SNR values are then stored in a memory of a scaling system of the decoder. The scaling system of the decoder then determines the SNR of the transmission channel and according to the determined SNR retrieves the corresponding scaling factor from the memory. The scaling factors are determined, for example, by simulating the predetermined performance of the decoder or, alternatively, in an empirical fashion.

Alternatively, the plurality of scaling factors corresponding to respective SNRs—SNR points or SNR ranges—are determined and in dependence thereupon a relationship between the scaling factors and the SNRs is determined. The scaling system of the decoder then determines the SNR of the transmission channel and according to the determined SNR determines the scaling factor using the relationship.

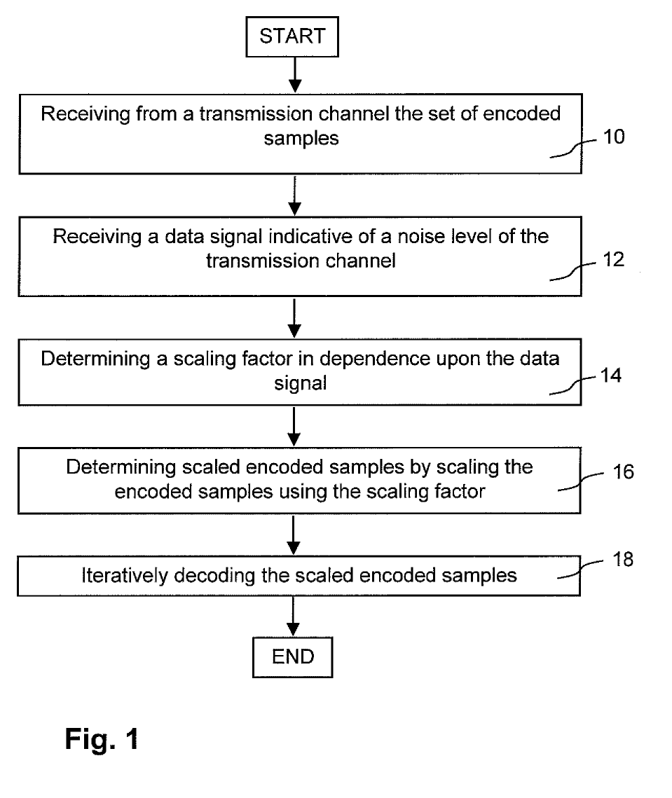

Referring to FIG. 1, a simplified flow diagram of a method for iteratively decoding a set of encoded samples according to an embodiment of the invention is shown. At 10, the set of encoded samples is received from a transmission channel. At 12, a data signal indicative of a noise level of the transmission channel is received, for example, from a monitor circuit for monitoring the noise level of the transmission channel. A scaling factor is then determined in dependence upon the data signal—14, followed by determining scaled encoded samples by scaling the encoded samples using the scaling factor—16. The scaled encoded samples are then provided to a decoder for iteratively decoding—18.

In an embodiment, corresponding scaling factors are determined for a plurality of noise levels and the same are stored in memory. The scaling factor—at 14—is then determined by retrieving from the memory a corresponding scaling factor in dependence upon the received data signal. The scaling factors are determined, for example, as described above, in a simulated or empirical fashion and memory having stored therein data indicative of the corresponding scaling factors is disposed in the scaling system of a specific type of decoder.

Alternatively, corresponding scaling factors are determined for a plurality of noise levels and a relationship between the noise level and the scaling factor is then determined in dependence thereupon. The scaling factor—at 14—is then determined in dependence upon the received data signal and the relationship. For example, the determination of the scaling factor using the relationship is implemented in hardware.

In a scaling method according to an embodiment of the invention, the scaling factor is employed or changed during execution of the iterative decoding process. For example, a scaling factor is first determined based on the noise level of the transmission channel, as described above, and then changed during the iterative decoding process. Alternatively, the scaling factor is determined independent from the noise level of the transmission channel during execution of the iterative decoding process.

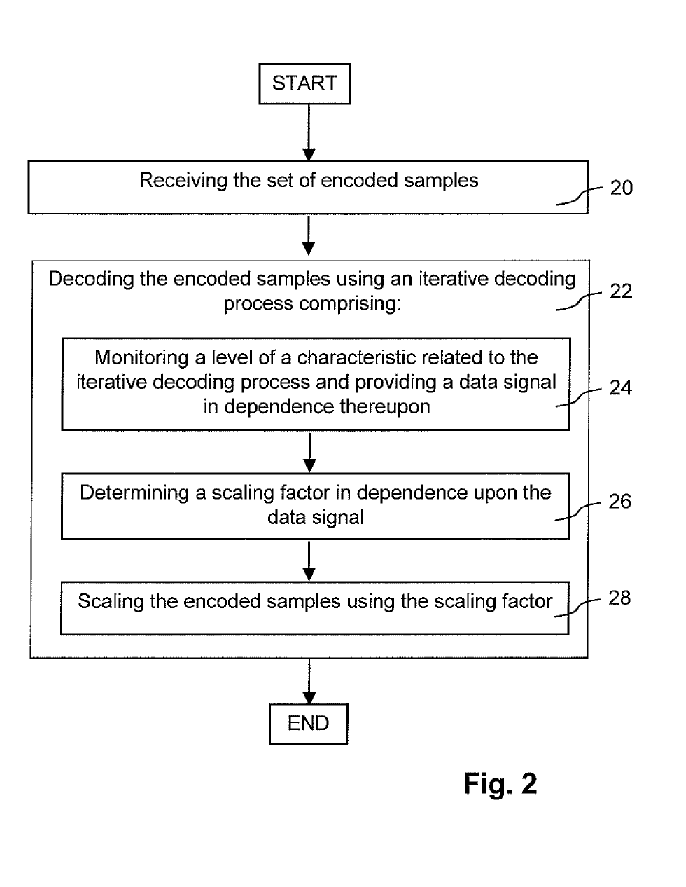

Referring to FIG. 2, a simplified flow diagram of a method for iteratively decoding a set of encoded samples according to an embodiment of the invention is shown. At 20, the set of encoded samples is received. At 22, the encoded samples are decoded using an iterative decoding process. The iterative decoding process comprises the steps: monitoring a level of a characteristic related to the iterative decoding process and providing a data signal in dependence thereupon—24; determining a scaling factor in dependence upon the data signal—26; and scaling the encoded samples using the scaling factor—28.

The level of the characteristic is monitored, for example, once at a predetermined number of iteration steps or a predetermined time instance. Alternatively, the level of the characteristic is monitored a plurality of times at predetermined numbers of iteration steps or predetermined time instances.

The scaling factor is determined, for example, once at a predetermined number of iteration steps or a predetermined time instance. Alternatively, the scaling factor is determined a plurality of times at predetermined numbers of iteration steps or predetermined time instances. This allows adapting of the scaling factor to the progress of the iterative process. For example, the scaling factor is gradually increased or decreased during the decoding process in order to accelerate convergence.

The level of the characteristic is, for example, related to: a number of iteration steps—for example, a number of decoding cycles; a dynamic power consumption—for example, the scaling factor is changed if the dynamic power consumption does not substantially decrease (indicating convergence); or a switching activity—for example, the scaling factor is changed if the switching activity does not substantially decrease (indicating convergence). For embodiments in which the level of the characteristic is related to the switching activity, the switching activity is optionally sensed at predetermined logic components of the decoder to determine whether it is increasing, decreasing, or remaining constant or similar.

In an embodiment, corresponding scaling factors are determined for a plurality of levels of the characteristic and the same are stored memory. The scaling factor—at 26—is then determined by retrieving from the memory a corresponding scaling factor in dependence upon the received data signal. The scaling factors are determined, for example, as described above, in a simulated or empirical fashion and memory having stored therein data indicative of the corresponding scaling factors is disposed in the scaling system of a specific type of decoder.

Alternatively, corresponding scaling factors are determined for a plurality of levels of the characteristic and a relationship between the levels of the characteristic and the scaling factor is then determined in dependence thereupon. The scaling factor—at 26—is then determined in dependence upon the received data signal and the relationship. For example, the determination of the scaling factor using the relationship is implemented in a hardware fashion.

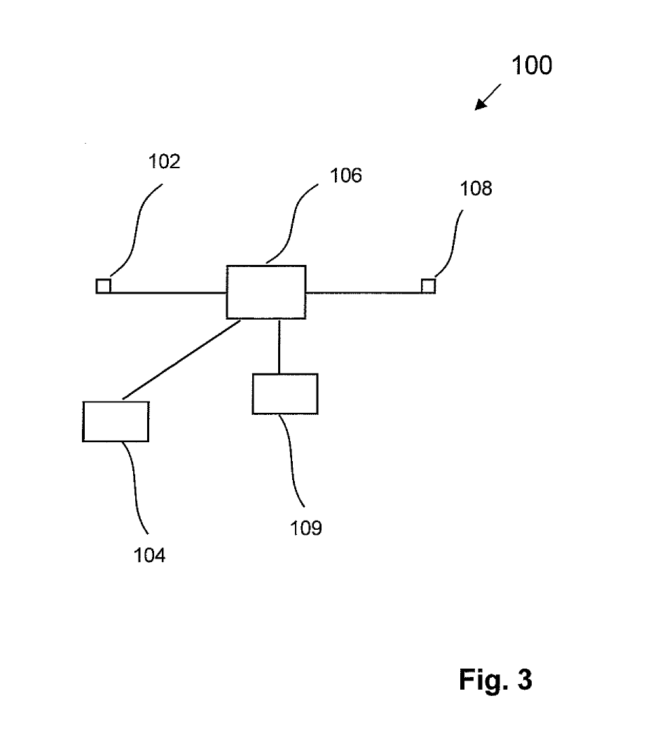

Referring to FIG. 3, a simplified block diagram of a scaling system 100 according to an embodiment of the invention is shown. The scaling system 100 enables implementation of the embodiments described above with reference to FIGS. 1 and 2. The scaling system 100 comprises an input port 102 for receiving a set of encoded samples. The set of encoded samples is for being decoded using an iterative decoding process. A monitor 104 monitors one of a noise level of a transmission channel used for transmitting the encoded samples and a level of a characteristic related to the iterative decoding process and provides a data signal in dependence thereupon. The monitor 104 is, for example, coupled to the transmission channel for monitoring the noise level of the same. Alternatively, the monitor 104 is coupled to: a power supply of the decoder for monitoring dynamic power consumption, logic circuitry of the decoder for monitoring a number of iteration steps or switching activity. Scaling circuitry 106 is connected to the input port 102 and the monitor 104. The scaling circuitry 106 determines a scaling factor in dependence upon the data signal and scaled encoded samples by scaling the encoded samples using the scaling factor. Output port 108 connected to the scaling circuitry 106 provides the scaled encoded samples to the decoder. Optionally, the system 100 comprises memory 109 connected to the scaling circuitry 106. The memory 109 has stored therein a plurality of scaling factors corresponding to a plurality of levels of the one of a noise level of a transmission channel used for transmitting the encoded samples and a level of a characteristic related to the iterative decoding process.

The above embodiments of the scaling method and system are applicable, for example, in combination with stochastic decoders and numerous other iterative decoders such as sum-product and min-sum decoders for improving BER decoding performance and/or convergence behavior.

Furthermore, the above embodiments of the scaling method and system are also applicable to various iterative signal processes other than decoding processes.

The above embodiments of the scaling method and system are applicable for different types of transmission channels other than AWGN channels, for example, for fading channels.

A major difficulty observed in stochastic decoding is the sensitivity to the level of switching activity—bit transition—for proper decoding operation, i.e. switching events become too rare and a group of nodes become locked into one state. To overcome this “latching” problem, Edge Memories (EMs) and Internal Memories (IMs) have been implemented to re-randomize and/or de-correlate the stochastic signal data streams as disclosed, for example, in US Patent Application 20080077839 and U.S. patent application Ser. No. 12/153,749 (not yet published).

EMs are memories assigned to edges in a factor graph for breaking correlations between stochastic signal data streams using re-randomization to prevent latching of respective Variable Nodes (VNs). Stochastic bits generated by a VN are categorized into two groups: regenerative bits and conservative bits. Conservative bits are output bits of the VN which are produced while the VN is in a hold state and regenerative bits are output bits of the VN which are produced while the VN is in a state other than the hold state. The EMs are only updated with regenerative bits. When a VN is in a state other than the hold state, the newly produced regenerative bit is used as the outgoing bit of the edge and the EM is updated with this new regenerative bit. When the VN is in the hold state for an edge, a bit is randomly or pseudo randomly chosen from bits stored in the corresponding EM and is used as the outgoing bit. This process breaks the correlation of the stochastic signal data streams by re-randomizing the stochastic bits and, furthermore, reduces the correlation caused by the hold state in a stochastic signal data stream. This reduction in correlation occurs because the previously produced regenerative bits, from which the outgoing bits are chosen while the VN is in the hold state, were produced while the VN was not in the hold state.

In order to facilitate the convergence of the decoding process, the EMs have a time decaying reliance on the previously produced regenerative bits and, therefore, only rely on most recently produced regenerative bits.

Different implementations for the EMs are utilized. One implementation is, for example, the use of an M-bit shift register with a single selectable bit. The shift register is updated with regenerative bits and in the case of the hold state a bit is randomly or pseudo randomly chosen from the regenerative bits stored in the shift register using a randomly or pseudo randomly generated address. The length of the shift register M enables the time decaying reliance process of the EM. Another implementation of EMs is to transform the regenerative bits into the probability domain using up/down counters and then to regenerate the new stochastic bits based on the measured probability by the counter. The time decaying processes are implemented using saturation limits and feedback.

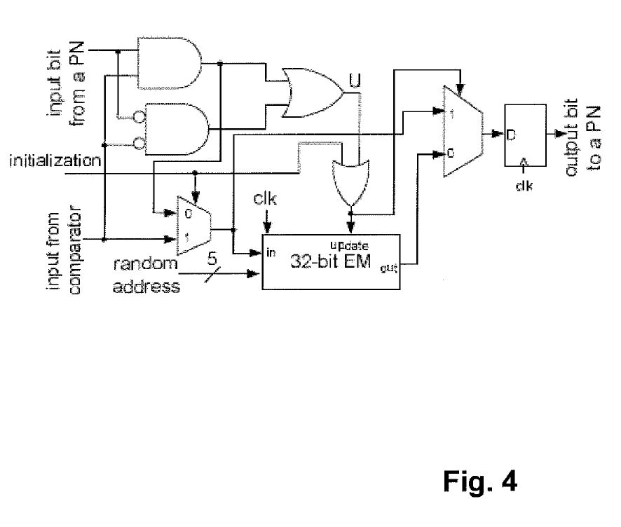

Referring to FIG. 4, a simplified block diagram of an architecture of a degree-3 VN with an EM having a length of M=32 is shown. The EM is implemented as a shift register with a single selectable bit using shift register look-up tables available, for example, in Xilinx Virtex architectures.

A VN as shown has two modes of operation: an initialization mode and a decoding mode. Prior to the decoding operation and when the channel probabilities are loaded into the decoder, the VNs start to initialize the respective EMs in dependence upon the received probability. Although it is possible to start the EMs from zero, the initialization of the EMs improves the convergence behavior and/or the BER performance of the decoding process. To reduce hardware complexity, the EMs are initialized, for example, in a bit-serial fashion. During the initialization, an output port of the comparator of the VN is connected to the respective EMs of the VN and the EMs are updated. Therefore, the initialization uses M Decoding Cycles (DCs) where M is the maximum length of the EMs. At low BERs, where convergence of the decoding process is fast, consuming M DCs for initialization substantially limits the throughput of the decoder.

In the decoding mode, the VN, as illustrated in FIG. 4, uses a signal U to determine if the VN is in the hold state—U=0—or in a state other than the hold state—U=1. When the VN is in a state other than the hold state, the new regenerative bit is used as the output bit and also to update the EM. In the hold state, a bit is randomly or pseudo randomly chosen from the EM using random or pseudo random addresses, which vary with each DC.

In a method for partially initializing EMs according to embodiments of the invention, the EMs are initialized to X bits, where X<M. For example, the EM of the VN illustrated in FIG. 4 is partially initialized to 16 bits. During this partial initialization, the EM is, for example, bit-serially updated with the output bits of the VN comparator for 16 DCs. After the EMs are partially initialized and the decoding operation begins, the Randomization Engine (RE) generates addresses in the range of [0, X−1], instead of [0, M−1], for T DCs. Due to the partial initialization at the beginning of the decoder operation, the range of random or pseudo random addresses is, for example, limited to 4 bits—i.e. 0 to 15—for 40 DCs. This process ensures that during the hold state, a valid output bit is retrieved from the EM. After this phase—for example, 40 DCs—the EM is updated and the RE generates addresses corresponding to the full range of the EM [0, M−1]. Values for T and X are, for example, determined by simulating the BER performance and/or the convergence behaviour of the decoding process. Alternatively, the values for T and X are determined in an empirical fashion. The method for partially initializing EMs reduces the number of DCs used for the initialization while enabling similar BER performance and/or convergence behavior to the full initialization, thus an increased throughput is obtained.

Optionally, the EM is updated in a fashion other than bit-serial, for example, 2 bits by 2 bits or in general K bits by K bits. Further optionally, the bits stored in a portion of the EM are copied to another portion of the EM using, for example, standard information duplication techniques. For example, during partial initialization half of the EM storage is filled with bits generated which are then copied to the remaining half of the EM storage, thus the reduction of addresses generated by the RE is obviated.

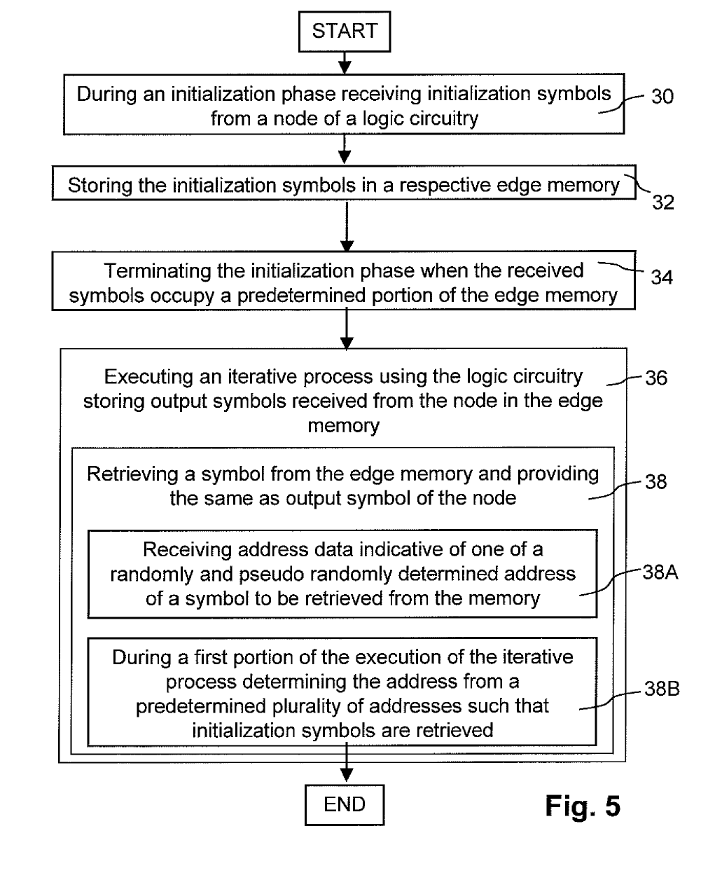

Referring to FIG. 5, a simplified flow diagram of a method for initializing edge memory according to an embodiment of the invention is shown. During an initialization phase initialization symbols are received—30—from a node of a logic circuitry such, as, for example, a VN of an iterative decoder. The initialization symbols are then stored in a respective edge memory—32. The initialization phase is terminated when the received symbols occupy a predetermined portion of the edge memory—34. An iterative process is then executed using the logic circuitry and output symbols received from the node are stored in the edge memory—36. During the execution of the iterative process a symbol is retrieved from the edge memory, for example, when a respective VN is in the hold state, and provided as output symbol of the node—38. At 38A, address data indicative of one of a randomly and pseudo randomly determined address of a symbol to be retrieved from the memory are received. During a first portion of the execution of the iterative process the address is determined from a predetermined plurality of addresses such that initialization symbols are retrieved—38B.

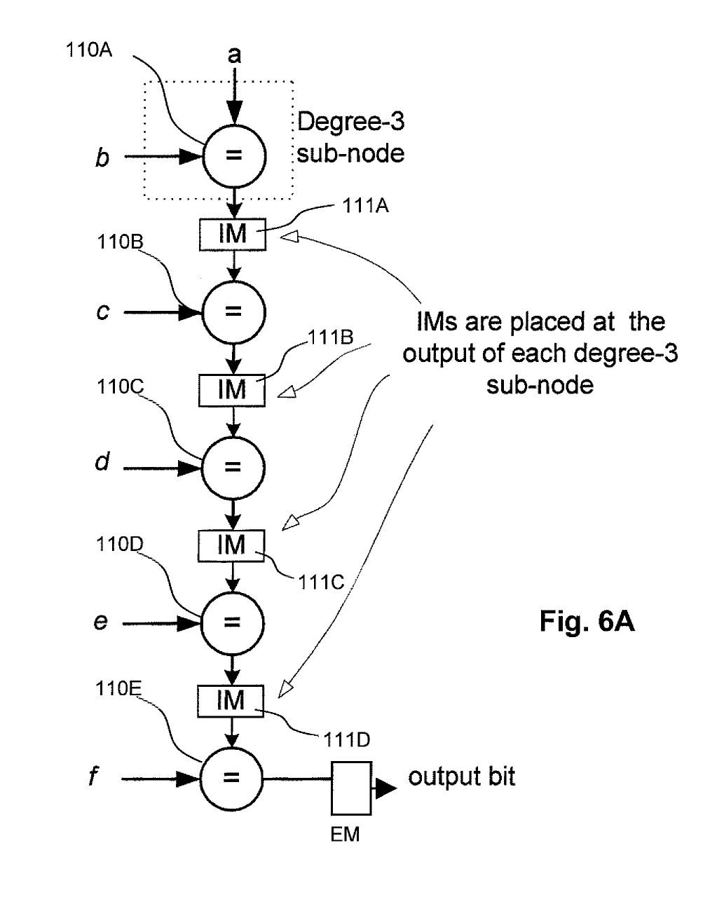

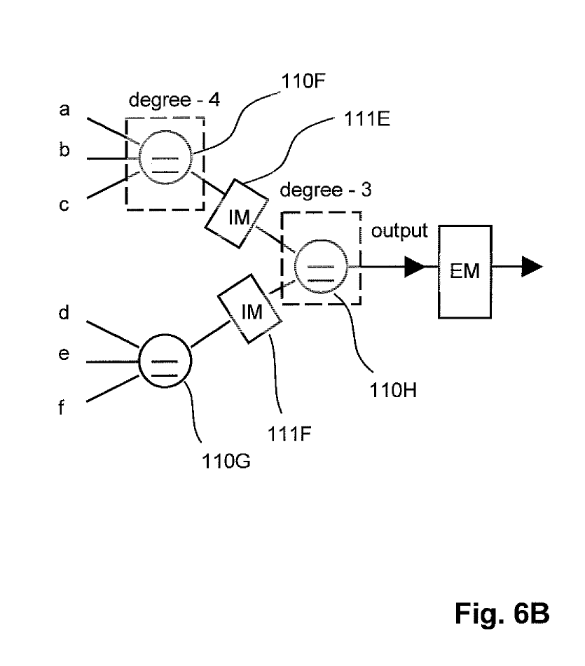

High-degree VNs are partitioned into a plurality of lower-degree variable “sub-nodes”—for example, degree-3 or degree-4 sub-nodes—with each lower-degree sub-node having an Internal Memory (IM) placed at its output port when the same is connected to an input port of a following sub-node. Referring to FIGS. 6A and 6B, simplified block diagrams of a 7-degree VN 110 are shown. There are different architectures realizable for partitioning a high-degree VN. For example, the 7-degree VN is partitioned into 5 degree-3 sub-nodes 110A to 110E, shown in FIG. 6A, or into 2 degree-4 and one degree-3 sub-nodes 110F to 110H, shown in FIG. 6B. Accordingly, 4 IMs 111A to 111D are placed at a respective output port of the first four degree-3 sub-nodes 110A to 110D in FIG. 6A, and 2 IMs 111E and 111F are placed at a respective output port of the first two degree-4 sub-nodes 110F and 110G in FIG. 6B. The operation of the IMs is similar to the one of the EMs. The difference is that the EM is placed at the output edge connected to a VN and is used to provide an output bit for the entire VN, while the IM is used to provide an output bit for only a sub-node within the VN.

The operation of a sub-node is then as follows:
1) When all input bits of the sub-node are equal, the sub-node is in the regular state, using the equality operation on the input bits to calculate the output bit. The IM is updated with the new output bit, for example, in a FIFO fashion.
2) When the input bits are not equal, the equality sub-node is in the hold state. In this case a bit is randomly or pseudo-randomly selected from the previous output bits stored in the IM and provided as the new output bit. The IM is not updated in the hold state.

In a high-degree VN a plurality of IMs are used to determine an output bit for each edge of the VN. For example, a degree-5 VN has 5 output ports corresponding to 5 edges and if this node is partitioned into degree-2 sub-nodes, 2 IMs are used per each output port, i.e. a total of 10 IMs. As the degree of the VN increases the number of IMs also increases.

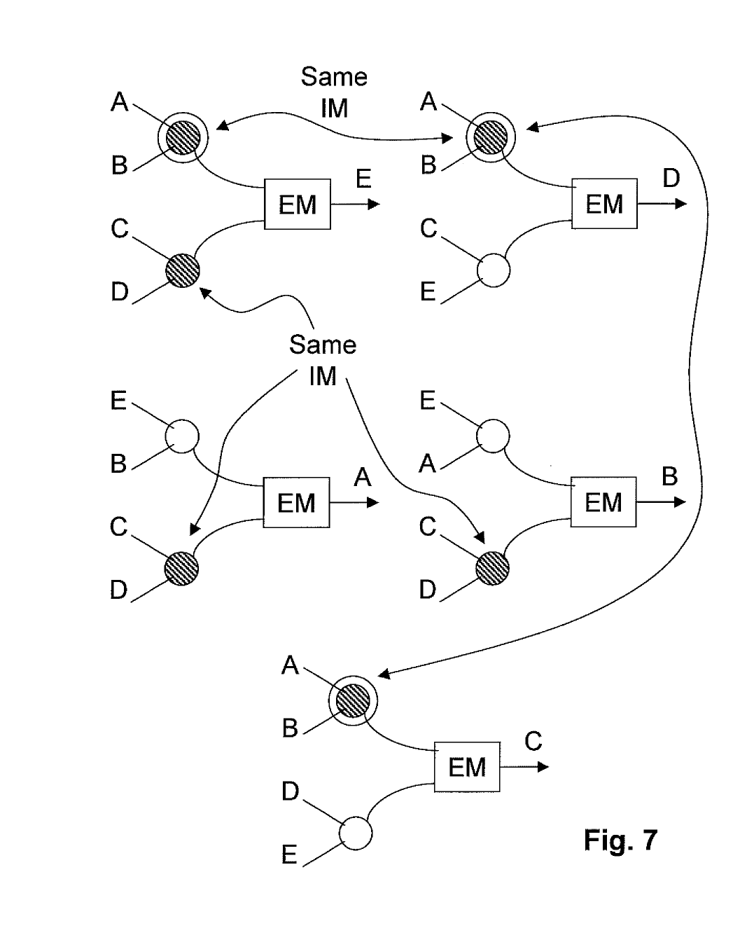

Referring to FIG. 7, a simplified block diagram of a high degree VN according to an embodiment of the invention is shown. FIG. 7 illustrates in an exemplary implementation a degree-5 VN partitioned into degree-2 sub-nodes. Here, sub-nodes receiving same input signal data share a same IM—indicated by shaded circles in FIG. 7. For example, up to 3 sub-nodes share a same IM in the architecture illustrated in FIG. 7. As a result, instead of 10 IMs only 6 IMs are employed for realizing the degree-5 node.

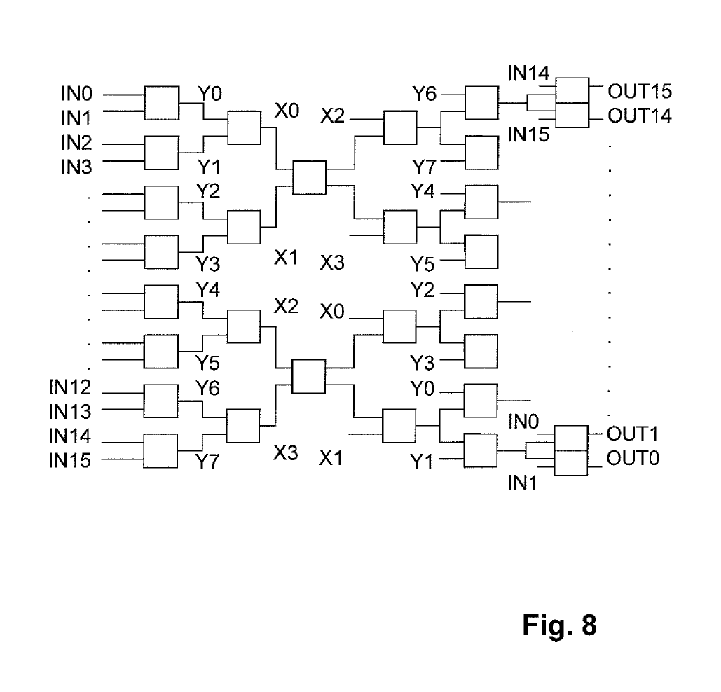

Referring to FIG. 8, a simplified block diagram for a very high degree VN according to an embodiment of the invention is shown. FIG. 8 illustrates an efficient degree-16 VN, although arbitrary degrees can be implemented similarly. Here, the architecture is based sharing sub-nodes effectively within a binary-tree structure with sub-nodes receiving same input signal data sharing a same IM. Accordingly this structure of high degree stochastic VNs is implementable with (3dᵥ−6) sub-nodes. Hence for dᵥ=16 in FIG. 8 this results in 42 sub-nodes. Hence when designing the architecture of a high degree VN, the VN is partitioned such that an architecture is determined in order to realize a maximum number of shared IMs in the VN.

Numerous other embodiments of the invention will be apparent to persons skilled in the art without departing from the spirit and scope of the invention as defined in the appended claims

What is claimed is:

1. A method for iteratively decoding a set of encoded samples comprising:
receiving from a transmission channel the set of encoded samples;
receiving a data signal indicative of a noise level of the transmission channel;
determining a scaling factor in dependence upon the data signal;
determining scaled encoded samples by scaling the encoded samples using the scaling factor; and
iteratively decoding the scaled encoded samples.

2. A method according to claim 1 further comprising:
determining corresponding scaling factors for a plurality of noise levels and storing the same in memory,
wherein determining the scaling factor comprises retrieving a corresponding scaling factor in dependence upon the received data signal.

3. A method according to claim 1 further comprising:
determining corresponding scaling factors for a plurality of noise levels; and
determining a relationship between the noise levels and the scaling factors,
wherein in the step of determining the scaling factor, the scaling factor is determined in dependence upon the received data signal and the relationship.

4. A method according to claim 3, wherein the corresponding scaling factors are determined such that one of BER performance, convergence, and switching activity of the iterative decoding process is optimized.

5. A method for iteratively decoding a set of encoded samples comprising:
receiving the set of encoded samples;
decoding the encoded samples using an iterative decoding process comprising:
monitoring a level of a characteristic related to the iterative decoding process and providing a data signal in dependence thereupon;
determining a scaling factor in dependence upon the data signal; and
scaling the encoded samples using the scaling factor.

6. A method according to claim 5, wherein the level of the characteristic is monitored at one of at least a predetermined number of iteration steps and at least a predetermined time instance.

7. A method according to claim 6, wherein the scaling factor is determined at a plurality of the one of at least a predetermined number of iteration steps and at least a predetermined time instance.

8. A method according to claim 5, wherein the level of the characteristic is related to at least one of a number of iteration steps, a dynamic power consumption, and a switching activity.

9. A method according to claim 6 further comprising:
determining corresponding scaling factors for a plurality of levels of the characteristic; and storing the same in memory,
wherein determining the scaling factor comprises retrieving a corresponding scaling factor in dependence upon the data signal.

10. A method according to claim 9 wherein the corresponding scaling factors are determined such that one of BER performance, convergence, and switching activity of the iterative decoding process is optimized.

11. A method according to claim 6 further comprising:
determining corresponding scaling factors for a plurality of levels of the characteristic; and
determining a relationship between the plurality of levels of the characteristic and the corresponding scaling factors,
wherein the scaling factor is determined in dependence upon the data signal and the relationship.

12. A method according to claim 11 wherein the corresponding scaling factors are determined such that one of BER performance, convergence, and switching activity of the iterative decoding process is optimized.

13. A scaling system comprising:
an input port for receiving a set of encoded samples, the set of encoded samples for being decoded using an iterative decoding process;
a monitor for monitoring at least one of a noise level of a transmission channel used for transmitting the encoded samples and a level of a characteristic related to the iterative decoding process and providing a data signal in dependence thereupon;
scaling circuitry connected to the input port and the monitor, the scaling circuitry for determining a scaling factor in dependence upon the data signal and for determining scaled encoded samples by scaling the encoded samples using the scaling factor; and
an output port connected to the scaling circuitry for providing the scaled encoded samples.

14. A scaling system according to claim 13 further comprising:
memory connected to the scaling circuitry, the memory for storing therein a plurality of scaling factors corresponding to a plurality of levels of the at least one of a noise level of a transmission channel used for transmitting the encoded samples and a level of a characteristic related to the iterative decoding process.

15. A method comprising:
during an initialization phase receiving initialization symbols from a node of a logic circuitry; storing the initialization symbols in an edge memory;
terminating the initialization phase when the received symbols occupy a predetermined portion of the edge memory;
executing an iterative process using the logic circuitry storing output symbols received from the node in the edge memory; and,
retrieving a symbol from the edge memory and providing the same as output symbol of the node.

16. A method according to claim 15, wherein the output symbols received from the node are stored in a portion of the memory other than the predetermined portion.

17. A method according to claim 15 further comprising:
receiving address data indicative of one of a randomly and pseudo randomly determined address of a symbol to be retrieved from the memory.

18. A method according to claim 17, wherein during a first portion of the execution of the iterative process the address is determined from a predetermined plurality of addresses such that initialization symbols are retrieved.

19. A method according to claim 15, wherein the initialization symbols are stored in a serial fashion.

20. A method according to claim 15, further comprising:
storing a copy of an initialization symbol in a portion of the memory other than the predetermined portion.

21. A logic circuitry comprising:
a plurality of sub nodes forming a variable node for performing an equality function in an iterative decoding process; and
internal memory interposed between the sub nodes such that the internal memory is connected to an output port of a respective sub node and to an input port of a following sub node, the internal memory for providing a chosen symbol if a respective sub node is in a hold state, and wherein at least two sub nodes share a same internal memory.

22. A logic circuitry as defined in claim 21, wherein the plurality of sub nodes is determined such that a number of shared internal memories is maximized.
